(19) United States
(12) Patent Application Publication
(10) Pub. No.: US 2005/0259836 A1
(43) Pub. Date: Nov. 24, 2005

(54) Multimedia recorder

(76) Inventor: Ming-Hsiang Yeh, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 10/851,195

(22) Filed: May 24, 2004

(51) Int. Cl. H04B 1/00; G09B 5/00

(52) U.S. Cl. 381/124; 704/272; 434/308

(57) ABSTRACT

The present invention is related to a multimedia recorder, which comprises a body, the body has a recording means for recording, a broadcasting means for broadcasting and a fastening member for bonding the body on a gift and being a part of a packing of the body and the gift; the body further has a LCD for displaying video information. Hence, the gift with the function of dynamic expression is able to vividly and brightly state the greeting from a gift sender and presented to a gift receiver face to face. Additionally the audio and video information is changeable.

### FIELD OF THE INVENTION

The present invention relates to a multimedia recorder, especially to the recorder with dynamical display function being fixed to a gift for promoting a gift purpose.

### BACKGROUND OF THE INVENTION

During the meaningful days, gift is normal but important, and it is to represent thoughts from a person who delivers a gift. Therefore, a card accompanied with the gift is full of greeting words usually to let a receiver understand what the person is trying to express. However, such expression with motionless state cannot reach a condition of surprising the receiver, and therefore it would be a restriction.

A music greeting card has being fashioned since a couple of years, and it functions to sing a song as a happy birthday to please a gift receiver, but hardly expressing the main thoughts from a gift sender and being not exclusive; otherwise, the greeting words is still a must to help approach advanced regards or blessing. As it can be seen, the music greeting card cannot be requested for such functions as well as today.

### SUMMARY OF THE INVENTION

The primary objective of the present invention is to provide a multimedia recorder, which is able to broadcast and record greeting sentences and be mounted on a gift. Hence, a static expression in prior arts may not exist, on the contrary, a brand new way of 3-dimension and vivid is brought out to make a gift receiver be physically surprised.

The second objective of the present invention is to provide a multimedia recorder, which having a LCD for displaying audio and video information simultaneously and lively.

The third objective of the present invention is to provide a multimedia recorder, which having plural types of fastening members thereon and being mounted on a gift for packing.

To reach above objectives, the multimedia recorder of the present invention comprises a body, which has a recording means, a broadcasting means and a fastening member; wherein the recording means includes a microphone and a recording key for recording, the broadcasting means includes a broadcasting key and a speaker for audio information, the fastening member functions to let the multimedia recorder be attached to a gift for vivid expression to a gift receiver.

The fastening member may be a sticker fixed on a bottom of the body, and the sticker is able to insert into a gift as flower basket for a combination; a top of the body is set a hole for gifts with sticker figures, and therefore the sticker is with the function of holding for the integration of the present invention and the gift. Hence, the features for the present invention are: a 3-dimension and static expression and exclusive packing purpose.

The fastening member may be a rope to go through two winding holes located on two sides of the body so as to that bonding the body on a book or a gift box. Then the body is integrated to be a part of the gift successfully.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

FIG. 1 is a 3-dimension view of an appearance of a first preferred embodiment of the present invention;

FIG. 2 is a schematic view of an application of the first preferred embodiment of the present invention;

FIG. 3 is a schematic view of an application of a second preferred embodiment of the present invention;

FIG. 4 is a schematic view of an application of a third preferred embodiment of the present invention;

FIG. 5 is a side view of a fourth preferred embodiment of the present invention.

### DETAILED DESCRIPTION OF THE PREFERRED EMBODIMENTS

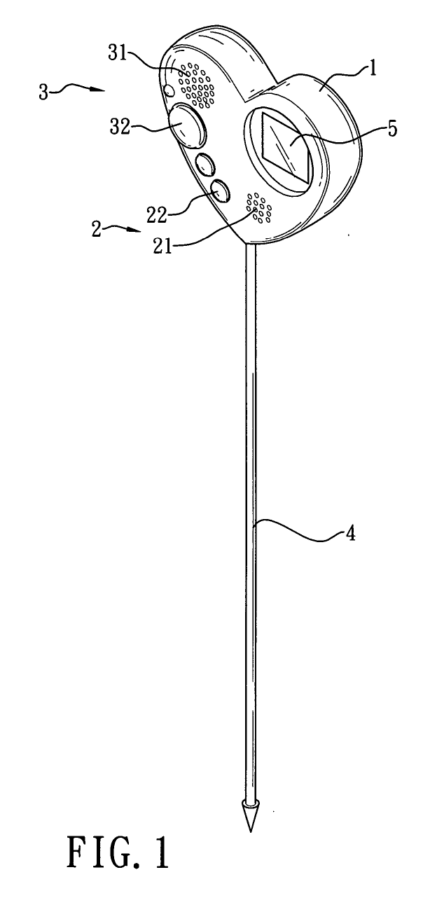

Please refer to FIG. 1, which is a 3-dimension view of an appearance of a first preferred embodiment of the present invention and comprises a body 1 having a recording means 2, a broadcasting means 3 and a fastening member 4.

The recording means 2 includes a microphone 21 and a recording key 22 for recording.

The broadcasting means 3 includes a speaker 31 and a broadcasting key 32 for broadcasting.

The fastening member 4 is combined to the body 1 so as to that fastening the body 1 on a gift, hence the gift is with the function of a dynamic expression, and the body 1 is a part of a gift packing after an integration of the body 1 and the gift.

The body 1 has a LCD 5 for displaying audio and video information.

By mean of the above multimedia recorder, a gift receiver is surprised by a vivid expression since the audio and video information prerecorded by a gift sender being broadcasting via the broadcasting means 3, and the gift receiver may then be deeply impressively.

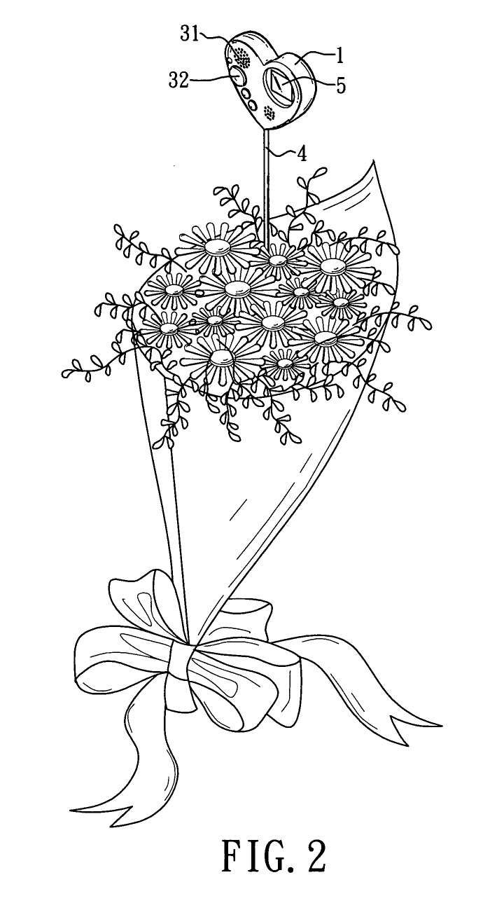

Aforesaid fastening member 4 on the body 1 is a sticker installed on a bottom of the body 1, thus the body 1 is able to insert into a gift for flower as flower basket for an integration of the body 1 and the gift, shown as FIG. 2. When the gift receiver obtains a flower, pressing on the broadcasting key 32 is to listen audio information as a vocal prerecorded by the gift sender and broadcasted by the speaker 31, such vocal being as the song of happy birthday, simultaneously video information is played by the LCD 5 for vividly and brightly conveying greeting and special meaning from the gift sender.

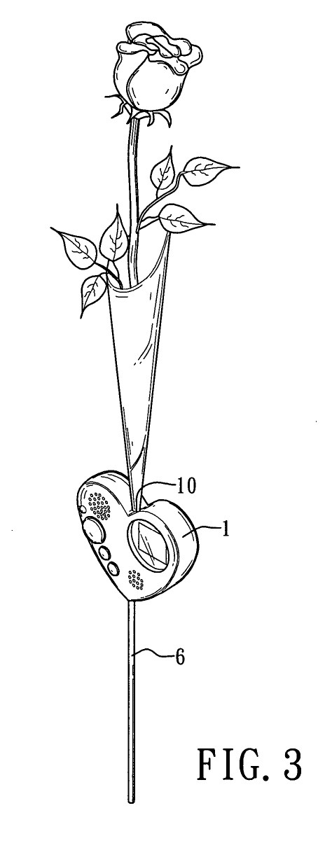

Please refer to FIG. 3, which is a schematic view of an application of a second preferred embodiment of the present invention. A top of the body 1 has a hole 10 for gifts with sticker shapes as flower, pen, etc. directly inserting into; a gripping shaft 6 is shaped on a bottom of the body 1 for the gift sender, a middleman or the gift receiver holding. As above design, any of additional parts as the hole 10 and the gripping shaft 6 integrated with the gift, the dynamic expression and the exclusive packing are much more creative than any of prior arts.

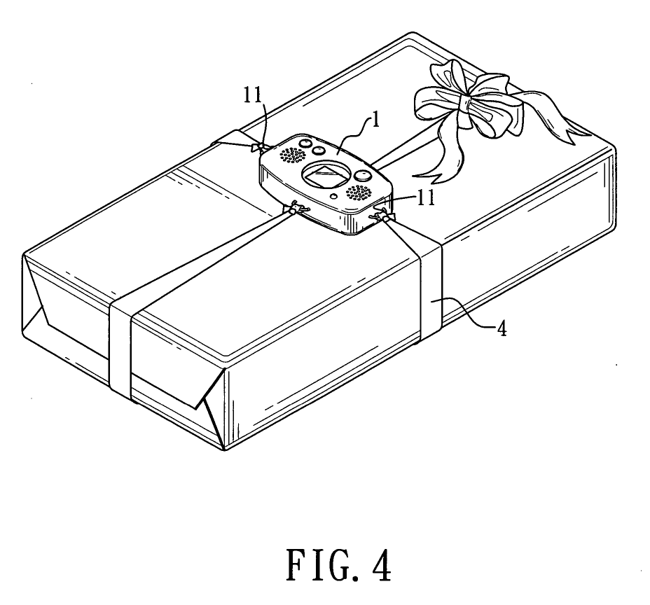

Please refer to FIG. 4, which is a schematic view of an application of a third preferred embodiment of the present invention. The gift is a book or a box packing, and two winding holes 11 are set on two sides of the body 1, the fastening member 4 is a rope to go through the winding holes 11 so as to that bonding the body 1 on the book or the box packing for integration. By means of the gift with special design, the gift receiver may then be more perceptual.

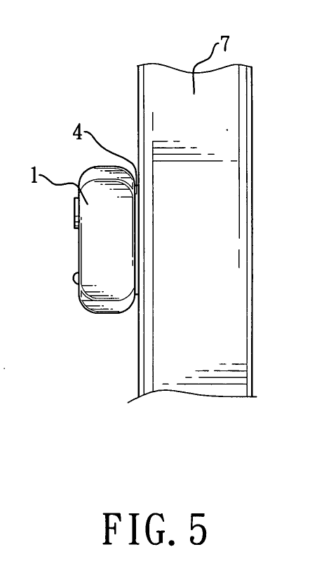

Please refer to FIG. 5, which is a side view of a fourth preferred embodiment of the present invention. The fastening member 4 is a viscous layer set on a back of the body 1 so as to that the body 1 being stuck on a gift 7.

The fastening member 4 aforesaid can be a brooch as well.

Additionally, the body 1 further comprises a lens for prerecording, the lens cooperates with the broadcasting means 3 and the LCD 5 for bright and vivid expression.

Further, the body comprises a storing means as a separate memory card and a USB interface for transmitting stored audio and video information to a computer so as to keep the precious information. Due to the storing means, the recorded audio and video information is changeable or repeated at different sites. Obviously it is the solution to that the music greeting card can only play with the same audio information. With the USB interface, the prerecording and pre-editing audio and video information in the computer is transferred to the present invention for broadcasting. The audio and video information can also be transmitted to another player by way of wireless transmission as infrared ray communication, blue tooth communication, frequency modulation communication, etc.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

1. A multimedia recorder comprising a body, the body having a recording means, a broadcasting means and a fastening member so as to fasten the body on a gift for dynamic expression.

2. The multimedia recorder as cited in claim 1, wherein the fastening member is a sticker installed on a bottom of the body for flower insertion.

3. The multimedia recorder as cited in claim 2, wherein a hole is located on a top of the body for gifts with sticker shapes as flower, pen.

4. The multimedia recorder as cited in claim 1, wherein the fastening member can be a rope to go through at least two winding holes located on two sides of the body so as to that bonding the body on a gift.

5. The multimedia recorder as cited in claim 1, wherein the fastening member is a viscous layer set on a back of the body so as to that the body being stuck on a gift.

6. The multimedia recorder as cited in claim 1, wherein the fastening member 4 aforesaid can be a brooch set on a back of the body.

7. The multimedia recorder as cited in claim 1, wherein the body further comprises a LCD for displaying audio and video information.

8. The multimedia recorder as cited in claim 1, wherein the body further comprises a lens.

9. The multimedia recorder as cited in claim 1, wherein the body further comprises a storing means.

10. The multimedia recorder as cited in claim 9, wherein the storing means is a separate memory card.

11. The multimedia recorder as cited in claim 1, wherein the body further comprises a USB interface for transmitting stored audio and video information to a computer.
